(19) United States
(12) Patent Application Publication
(10) Pub. No.: US 2021/0381570 A1
(43) Pub. Date: Dec. 9, 2021

(54) ADJUSTABLE VIBRATION DAMPER

(71) Applicant: ZF FRIEDRICHSHAFEN AG, Friedrichshafen (DE)

(72) Inventors: Bernd ZEISSNER, Volkach (DE); Lukas RUHMANN, Memmelsdorf (DE); Thomas MANGER, Wasserlosen (DE); Stefan SCHMITT, Gocheim (DE); Thomas SOLF, Sulzheim (DE)

(21) Appl. No.: 16/650,119

(22) PCT Filed: Aug. 13, 2018
(86) PCT No.: PCT/EP2018/071851

§ 371 Date: Mar. 30, 2020

(30) Foreign Application Priority Data
Sep. 25, 2017 (DE) 10 2017 216 922.2

(51) Int. Cl. F16F 9/18; F16F 9/32; F16F 9/43

(52) U.S. Cl. CPC F16F 9/18; F16F 9/325; F16F 9/435; F16F 9/3271; F16F 2230/0005; F16F 2232/08; F16F 2234/02; F16F 2228/066; F16F 2226/04; F16F 2222/12

(57) ABSTRACT

An adjustable vibration damper has at least one adjustable damping valve, a piston at a piston rod that divides a cylinder into a work chamber on the piston rod side and a work chamber on the side remote of the piston rod. A hydraulic device is connected via a first line to the at least one adjustable damping valve connected to one of the work chambers and via a second line at least indirectly to the other working chamber.

### CROSS REFERENCE TO RELATED APPLICATIONS

This is a U.S. national stage of Application No. PCT/EP2018/071851 filed Aug. 13, 2018. Priority is claimed on German Application No. DE 10 2017 216 922.2 filed Sep. 25, 2017 the content of which is incorporated herein by reference.

### 1. FIELD OF THE INVENTION

The invention is directed to an adjustable vibration damper.

### 2. DESCRIPTION OF RELATED ART

A concept for an adjustable vibration damper is known from DE 10 2014 225 930 A1. The adjustable vibration damper additionally has a hydraulic device connected to a work chamber on the piston rod side and to a work chamber on the side remote of the piston rod to circulate hydraulic medium between the two work chambers. This document describes the vibration damper without giving design details.

An adjustable vibration damper with two externally adjustable vibration dampers has at least one intermediate tube which virtually completely outwardly envelops a cylinder in which the piston rod slides and which forms the two work chambers. DE 10 2005 053 394 A1 is cited by way of example.

Based on DE 10 2005 053 394 A1, it appears impossible to realize a vibration damper with the operating principle according to DE 10 2014 225 930 A1. The length of the intermediate tube could be shortened to achieve radial access to the intermediate tube. This would also entail a loss of usable stroke length of the piston rod because, otherwise, the piston could be located axially outside of a connection opening between the work chamber on the piston rod side and an intermediate tube and, therefore, no damping medium would be displaced into the adjustable damping valve.

Alternatively, according to the teaching of DE 34 006 875 A1 one damping valve could be arranged in the area of the piston rod guide and one damping valve could be arranged in the area of the cylinder base. An intermediate tube could then be dispensed with because the damping medium would be connected directly to the respective work chamber. However, this would require different constructional forms of the adjustable damping valve, and different constructional forms of the adjustable damping valves would render the product disproportionately expensive.

### SUMMARY OF THE INVENTION

An object of one aspect of the present invention is a hydraulic device to be connectable to a vibration damper in an economical manner.

According to one aspect of the invention, a hydraulic device is connected via a first line to the at least one adjustable damping valve which is connected to one of the work chambers and via a second line at least indirectly to the other working chamber.

According to one aspect of the invention an external connection point that already exists at the cylinder for the adjustable damping valve is also used for the hydraulic device, which results in a compact connection technique.

Insofar as two adjustable damping valves are used, it can be provided that the hydraulic device is connected via the first line to one of the two adjustable damping valves and via a second line to a second adjustable damping valve. In this case, no modifications need be carried out at all on the cylinder for the connection of the hydraulic device.

In a further advantageous configuration, the at least one adjustable damping valve is connected to the cylinder via a pipe connection piece, and the pipe connection piece has a connection opening for the hydraulic device. The pipe connection piece is a component part that can be positioned separate from the cylinder and which has an appreciably greater degree of design freedom than a simple cylinder with a constant wall thickness. Therefore, the connection technique can be carried out substantially better in the pipe connection piece.

Optionally, the pipe connection piece can also be formed of multiple parts, one pipe portion forming the connection to the cylinder and one pipe portion forming an adapter with the connection opening. This mode of construction affords the possibility that the pipe portion fastened to the cylinder can be constructed as a standard component part which is usable in a vibration damper with or without a hydraulic device.

It can be provided that the adjustable damping valve is connected to the work chamber via a fluid connection. The fluid connection is formed by an intermediate tube connected to the adjustable damping valve via a connection sleeve connected to the connection opening. The connection sleeve guides the damping medium path between the fluid connection and, accordingly, to the adjustable damping valve and to the hydraulic device.

To facilitate assembly, the connection sleeve is connected to the connection opening via an annular channel. There is then no need to pay attention to the orientation of the connection sleeve in circumferential direction during assembly.

A further step for facilitating the adaptation of the hydraulic device consists in that the connection opening is constructed as part of a radial channel. The radial channel bridges the flow path between the connection opening and the inlet of the adjustable damping valve.

In order to facilitate assembly of the line as far as possible, so that there is no collision of component parts, one of the connection openings has a greater axial distance from the cylinder than the other connection opening. Accordingly, the lines extend in different planes.

A step which aims in this direction consists in that the connection opening is arranged to be offset in circumferential direction relative to an electric connection for the adjustable damping valve.

### BRIEF DESCRIPTION OF THE DRAWINGS

The invention will be described in more detail referring to the following description of the figures.

FIG. 1 is a diagram of an adjustable vibration damper;

FIGS. 2 and 3 are sectional view of a vibration damper; and

FIG. 4 is a detail of the vibration damper according to FIGS. 2 and 3.

### DETAILED DESCRIPTION OF THE PRESENTLY PREFERRED EMBODIMENTS

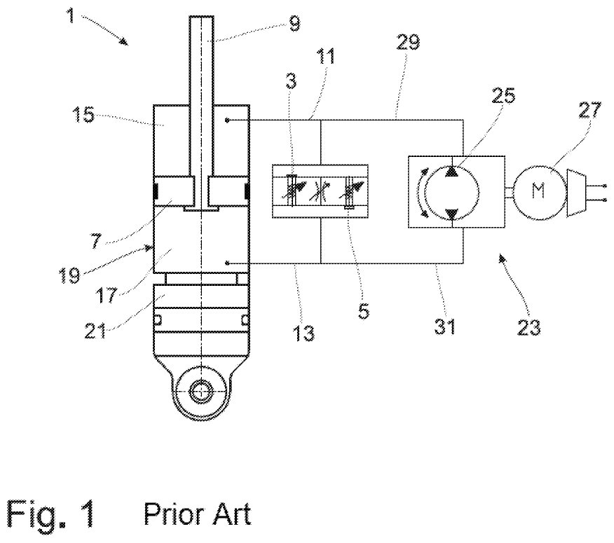

FIG. 1 shows the equivalent diagram of an adjustable vibration damper 1 with adjustable damping valves 3; 5, respectively, for a movement direction of a piston 7 at a piston rod 9. Reference is made to DE 10 2015 2000 348 A1 as regards the constructional layout of the adjustable damping valves. The two adjustable damping valves 3; 5 are connected to a work chamber 15; 17, respectively, via a fluid connection 11; 13.

The piston 7 divides a cylinder 19 which is completely filled with damping medium into a work chamber 15 on the piston rod side and a work chamber 17 remote of the piston rod. A compensation space 21 compensates for the damping medium volume displaced by the piston rod 7.

Hydraulically parallel to the two damping valves 3; 5, the vibration damper 1 has a hydraulic device 23 comprising a pump 25 with two conveying directions and a drive motor 27, preferably an electric motor. The hydraulic device 23 is likewise connected to the two work chambers 15; 17 via two lines 29; 31 and accordingly allows damping medium to be circulated between work chambers 15; 17 to exert additional actuating forces on the piston rod 9.

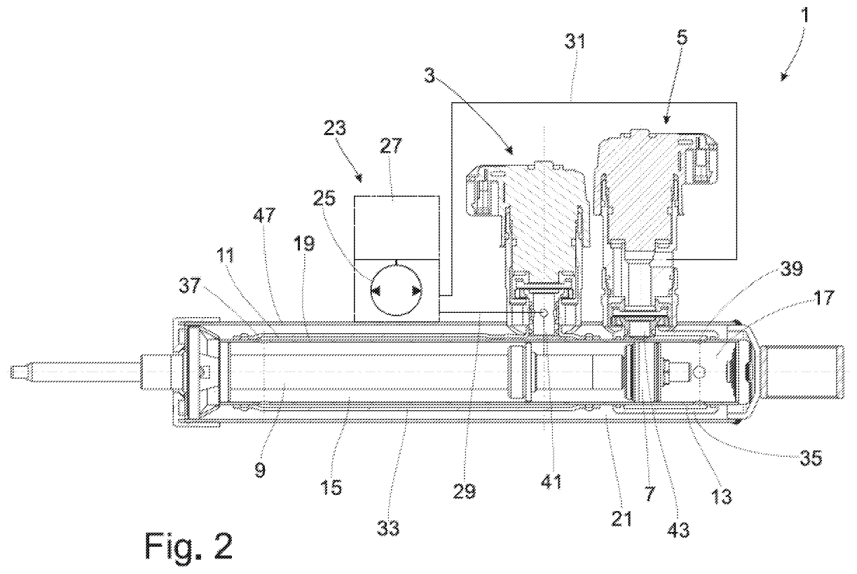

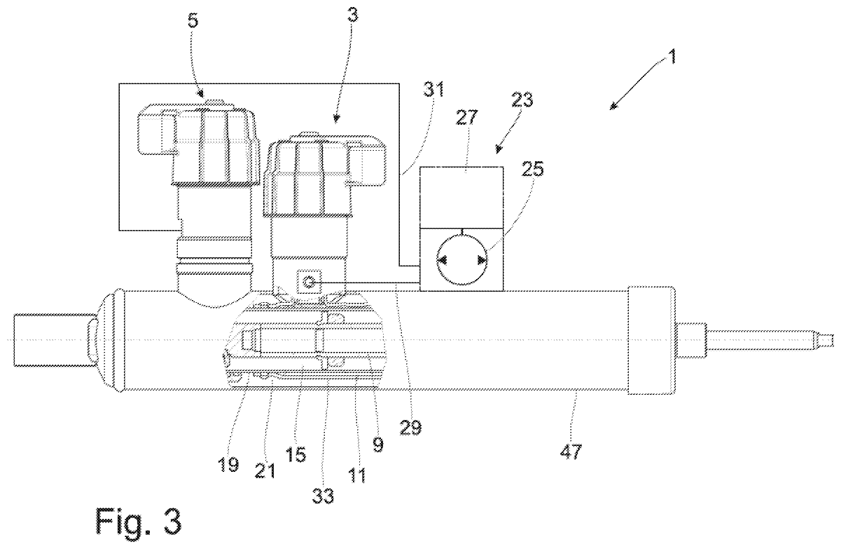

FIGS. 2 and 3 show a vibration damper 1 according to the equivalent diagram of FIG. 1. In addition to the cylinder 19, the vibration damper 1 has an intermediate tube 33; 35 connected to one of the work chambers 15; 17 and one of the adjustable damping valves 3; 5. For this purpose, a connection opening 37 that, with the first fluid connection 11, leads to the first adjustable damper 3 is formed in the work chamber 15 on the piston rod side for the first intermediate tube 33. The work chamber 17 remote of the piston rod also has a connection opening 39 of this kind to the second fluid connection 13. Fluid connections 11; 13 are formed, respectively, by the intermediate tubes 33; 35 and the portions of cylinder 19 enclosed by the intermediate tubes 33; 35.

The two adjustable damping valves 3; 5 are only shown as equivalent diagrams. However, to make it easier to distinguish between them a hydraulic connection 41; 43 is shown, which forms the connection between the fluid connection and the connected adjustable damping valve.

Further, it can be seen from FIG. 2 that the hydraulic device 23 is connected to the adjustable damping valve 3 of the work chamber 15 on the piston rod side via the first line 29 and is connected to the adjustable damping valve of the work chamber 17 remote of the piston rod via the second line 31. In this specific example, the two work chambers 15; 17 have a fluid connection 11; 13 to an adjustable damping valve 3; 5, respectively, and the hydraulic device 23 is connected via its lines 29; 31, respectively, to one of the damping valves 3; 5.

The compensation space 21 extends completely concentric to cylinder 19 and is radially limited by an outer reservoir tube. The reservoir tube serves as a support for the two adjustable damping valves 3; 5 and possibly for the hydraulic device 23.

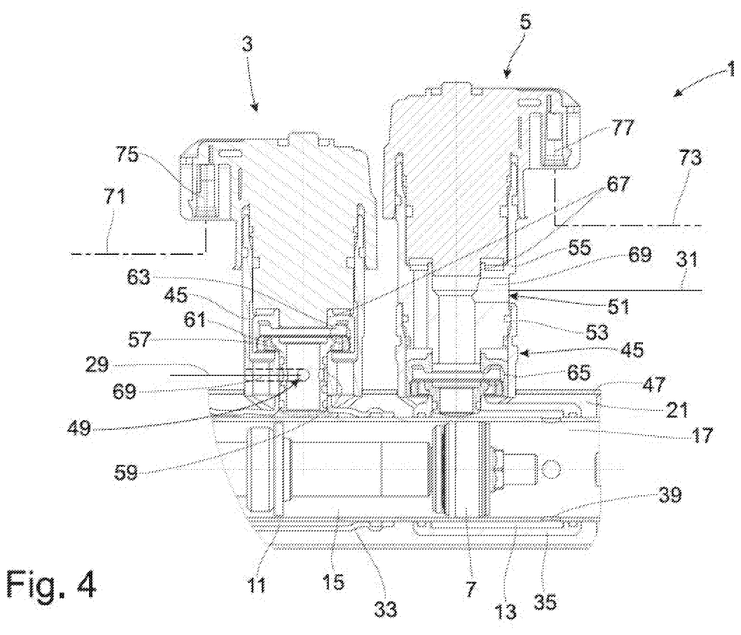

FIG. 4 shows a detail from FIG. 2 from which it is apparent that the adjustable damping valves 3; 5 are connected to the cylinder 19 via a pipe connection piece 45. The pipe connection piece 45 is part of an outer reservoir tube 47 and is welded to the latter. Optionally, the pipe connection piece 47 can also be formed integral with the reservoir tube 47. The pipe connection piece 47 has a connection opening for the hydraulic device 23. Two preferred embodiments are shown in FIG. 4.

The pipe connection piece 45 for the damping valve 5 connected to the work chamber 17 remote of the piston rod, for example, is formed of multiple parts. A first pipe portion 53 forms the connection to the cylinder 19 and is fixedly connected to the reservoir tube 47. A further pipe portion 55 is arranged in this pipe portion 53 and forms an adapter with the connection opening 51. The further pipe portion 55 can be oriented rotationally in any desired manner with respect to the pipe portion 53 on the reservoir tube side.

For example, the adjustable damping valve 3 of the work chamber 15 on the piston rod side is likewise connected via fluid connection 11 to work chamber 15, and the fluid connection is formed by the intermediate tube 33, which is connected to the adjustable damping valve 3 via a connection sleeve 57 connected to the connection opening 49. The connection sleeve 57 provides for an installation space for arranging the connection opening 49. In this construction mode, the connection sleeve 57 can also have any orientation in circumferential direction, since the connection sleeve 57 is connected to the connection opening 49 via an annular channel 59. The connection sleeve 57 can also be a seat surface for a check valve 63; 65, which is usable in a particularly meaningful manner when the two adjustable damping valves 3; 5 are connected to a common compensation space 21. The check valves 63; 65 always open when the work chamber 15; 17 associated with the damping valve 3; 5 becomes larger as a result of a piston movement. Damping medium can then flow out of the compensation space 31 in the work chamber 15; 17 via the check valve 15; 17. When there is incident flow from the work chamber 15; 17 into the fluid connection 11; 13, the check valve closes and the damping medium flows on into a space between the check valve 63; 65 and inlet opening 67 into the adjustable damping valve 3; 5. The flow from the damping valve 3; 5 into the compensation space of the pipe connection piece 45 takes place radially offset to the inlet opening 67.

In both embodiment forms, the connection opening 49; 51 is part of a radial channel 69 which the distance between an outer lateral surface of the pipe connection piece 45 and of the hydraulic connection 41; 43 of the fluid connection to the adjustable damping valve. The two variants are shown in combination in this view. In principle, however, one of the two construction forms could also be provided for both connection openings 49; 51.

FIG. 4 illustrates that one of the connection openings 49; 51 can have a greater axial distance from cylinder 19 than the other connection opening. The lines 29; 31 can accordingly be installed in different planes with respect to the reservoir tube 47.

Lines 29; 31 run in an installation space, which will possibly also be needed for lines 71; 51 of an electric connection 75; 77 of the adjustable damping valves. The electric connection 75; 77 serves, inter alia, for the power supply of a coil, not shown. It will likewise be apparent from FIG. 4 that the connection opening 49; 51 can be arranged to be offset in circumferential direction relative to an electric connection 75; 77 for the adjustable damping valve 3; 5.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design

1.-10. (canceled)

11. An adjustable vibration damper comprising:
a cylinder;
at least one adjustable damping valve;
a piston rod;
a piston at the piston rod that divides the cylinder into two work chambers, a first work chamber on a piston rod side and a second work chamber on a side remote of the piston rod;
a first line;
a second line; and
a hydraulic device connected via the first line to the at least one adjustable damping valve, which is connected to one of the two work chambers, and via the second line at least indirectly to the other of the two work chambers.

12. The adjustable vibration damper according to claim 11, wherein the hydraulic device is connected via the first line to a first adjustable damping valve of the at least one adjustable damping valve and via a second line to a second adjustable damping valve of the at least one adjustable damping valve.

13. The adjustable vibration damper according to claim 11, further comprising:
a pipe connection piece having at least one connection opening for the hydraulic device and configured to connect the at least one adjustable damping valve to the cylinder.

14. The adjustable vibration damper according to claim 13,
wherein the pipe connection piece is formed of multiple portions, wherein a first pipe portion is configured as a connection to the cylinder and a second pipe portion is configured as an adapter comprising the at least one connection opening.

15. The adjustable vibration damper according to claim 13,
wherein the at least one adjustable damping valve is connected to one of the two work chambers via a fluid connection, and
wherein the fluid connection comprises an intermediate tube connected to the at least one adjustable damping valve via a connection sleeve which is connected to the at least one connection opening.

16. The adjustable vibration damper according to claim 15, further comprising:
an annular channel configured to connect the connection sleeve to the at least one connection opening.

17. The adjustable vibration damper according to claim 13, wherein the at least one connection opening is constructed as a portion of a radial channel.

18. The adjustable vibration damper according to claim 13, wherein one of the at least one connection opening has a greater axial distance from the cylinder than an other of the at least one connection opening.

19. The adjustable vibration damper according to claim 13, wherein the at least one connection opening is arranged to be offset in circumferential direction relative to an electric connection for the at least one adjustable damping valve.
